(19) United States
(12) Patent Application Publication
(10) Pub. No.: US 2007/0039658 A1
(43) Pub. Date: Feb. 22, 2007

(54) SYSTEM, METHOD AND DEVICE FOR APPLYING A PROTECTIVE WRAP TO A PIPE PORTION

(76) Inventor: Kevin Douglas, Ann Arbor, MI (US)

Correspondence Address: DOBRUSIN & THENNISCH PC, 29 W LAWRENCE ST, SUITE 210, PONTIAC, MI, 48326, US

(21) Appl. No.: 11/420,626

(22) Filed: May 26, 2006

Related U.S. Application Data
(60) Provisional application No. 60/684,835, filed on May 26, 2005.

(51) Int. Cl. F16L 9/14

(52) U.S. Cl. 138/146

(57) ABSTRACT

The present invention provides a system, method and device for the protecting underground pipe portions from corrosion by providing applying a wrap having an anti-corrosion agent over the pipe portion to form a seal with an anti-corrosion agent.

### FIELD OF THE INVENTION

The present invention relates generally to system, method and device for the protection of underground pipe portions from corrosion.

### BACKGROUND

Utility companies, such as natural gas utility companies, utilize underground pipes for servicing regions. Such pipes are typically pre-coated with a protective layer for preventing corrosion from conditions typically encountered underground (e.g., moisture, moving earth or otherwise). For example, such coatings may include fusion bonded epoxies, extruded polyethylene, coal tar enamel, asphalt enamel and combinations thereof or otherwise. Specific coatings, by name, include 3M™ Scotchkote™, Dupont NAP-GARD®, and ShawCor (Canusa-CPS).

However, from time to time, these coating are intentionally or unintentionally removed thereby subjecting the pipe portion to the sounding environmental conditions. This is commonly referred to as a holiday formed in the coating of the pipe. Accordingly, it is desired to cover these holidays to provide protection to these holidays to prevent corrosion.

In another aspect, in accessing underground pipe portions, it is becoming common for utility companies to form keyholes within the ground. These keyholes typically comprise substantially vertical holes formed over the pipe portions, wherein the diameter of the holes is approximately one half meter or less. Often times, crude or makeshift tools are used to repair or modify the pipe portions due to the depth and space restrictions of the pipes within the keyhole.

Accordingly, there is a need for a system, method and device of covering holidays formed in the protective coatings of pipe portions, particularly pipe portion located underground which are accessed through a keyhole formed in the ground surface.

### SUMMARY OF THE INVENTION

The present invention meets the above needs by providing a system, method and device for covering underground pipe portion, particularly coating holidays, which are accessed by forming a keyhole within the ground.

In one aspect, the present invention provides a system for applying a protective wrap to a pipe portion. The system may include a lift body being attached or including a handle for lowing into a hole and an extendable member moveably attached to the lift body, wherein the extendable member includes an engagement feature adapted to extend and retract with respect to the lift body. The system may also include a support member attached or movable with the lift body which includes a retention member for temporarily securing a protective wrap thereto. The system may furthering include a drive mechanism for providing an application of force to the extendable member to extend, retract, or extend and retract the engagement feature and a control module for controlling the application of force by the drive mechanism. It should be appreciated that other configurations are available as described herein.

In another aspect, the present invention also provides a method of applying a protective wrap to a pipe portion within a keyhole. The method includes the steps of: i) forming a hole to expose an underground pipe portion, the underground pipe portion having a holiday formed in a protective coating of the pipe portion; ii) lowering a wrapping system within the hole, the wrapping system including: a lift body being attached or including a handle for lowing into a hole, an extendable member movably attached to the lift body and including an engagement feature adapted to extend and retract with respect to the lift body and a support member including a retention member for temporarily securing a protective wrap thereto; iii) placing the support member below the pipe portion; iv) extending the engagement feature to a ground surface forming the bottom of the hole, continually extending the engagement feature with respect to the lift body to raise the support member until the protective wrap come in at least partially contact with the pipe portion; v) wrapping any remaining portion of the wrap around the pipe portion; vi) retracting the engagement feature causing the support member to move away from the pipe portion; and vii) removing the wrapping system from the hole. It should be appreciated that other method configurations are available as described herein.

### DESCRIPTION OF THE DRAWINGS

FIG. 1 illustrates a perspective view of one exemplary embodiment of the system of the present invention.

FIG. 2 illustrates another perspective view of the embodiment shown in FIG. 1.

FIG. 3 illustrates yet another perspective view of the embodiment shown in FIG. 1.

FIG. 4 illustrates a control module according to the teachings of the present invention.

FIGS. 5a and 5b illustrates two finishing tool according to the teachings of the present invention.

FIGS. 6 through 10 illustrate various steps in the application of a wrap to a pipe portion using the system of the present invention.

FIGS. 11 and 12 illustrate two views of an alternate support and retention feature for a wrap.

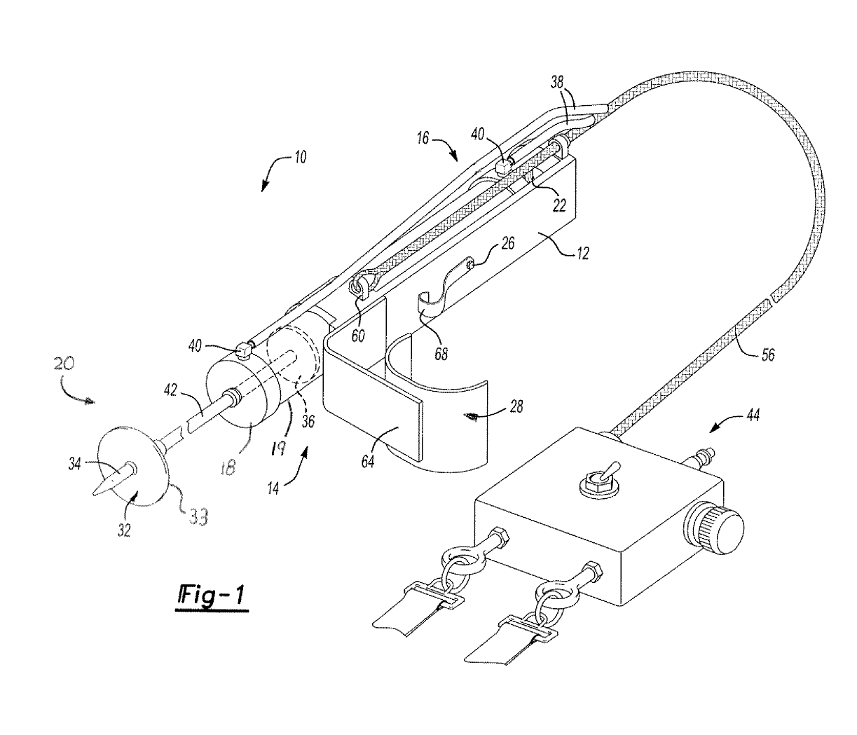

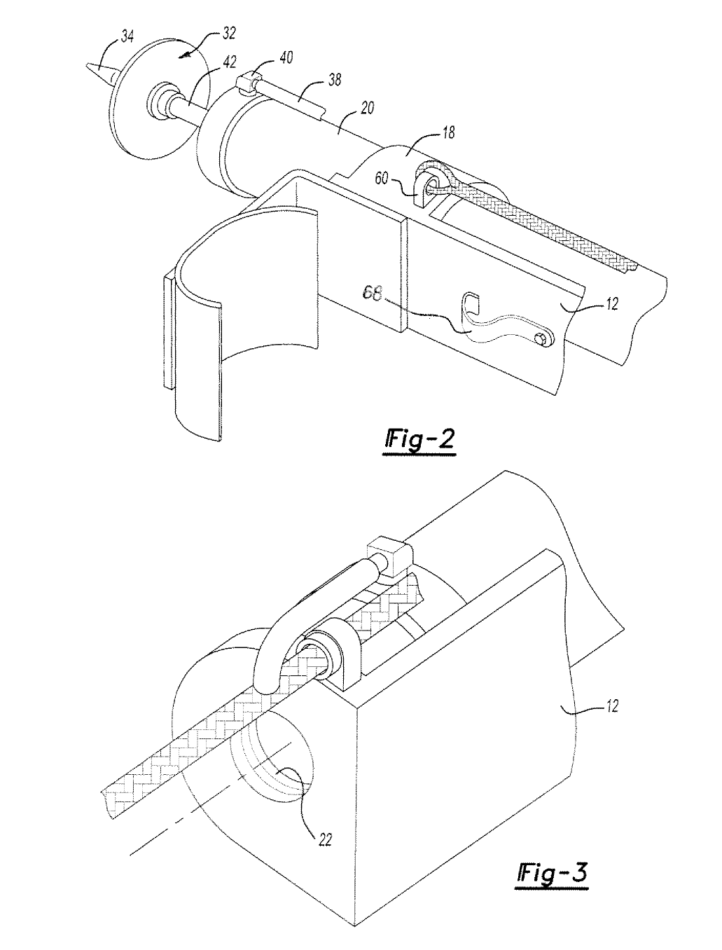

### DETAILED DESCRIPTION OF THE INVENTION

The present invention provides a system, method and device for applying a protective layer to a pipe portion located within a keyhole formed in a ground surface. The device is configured for placement within a keyhole and includes retention and support means for holding and supporting a wrap. The wrap is configured in shape to at least partially or substantially wrap around a pipe portion and includes an agent for assisting in the prevention of corrosion to the pipe portion. With the use of the device of the present invention, a wrap is placed about at least a portion of the pipe portion with substantially no required entrance of the user within the keyhole.

Referring to drawings, one exemplary embodiment of the system 10 of the present invention is show. The system includes a lift body member 12 having a length with a first end 14 and a second end 16. The lift body member is configured to receive an application of force to raise or lower the lift body member within a hole, particularly with respect to a ground surfaces thereof. The lift body member is configured with a first attachment or engagement feature 18 for moveable attachment to an extendable member 20, a second attachment feature 22 (such as a threaded portion) for attachment to a handle portion 24 (e.g., rod, stick or otherwise), and a third attachment feature 26 for attachment to a support member 28. However, it should be appreciated that the attached components to the first, second or third attachment features may be integrally formed with the lift body member or the lift body member may be otherwise configured.

The lift body member may comprise a frame or bracket member for the mounting or forming of the attachment feature or the support member. The lift body member may also include a cylinder body 19 attached or formed with the lift body member for receiving all or a portion of the extendable member.

The cylinder body is configured for receiving and guiding the extendable member, and more particularly a drive piston, as described herein. Accordingly, the cylinder body may include a cross-sectional cavity similar or substantially identical to that of the drive piston. The cylinder may include one or two pressure chambers formed between end walls of the cylinder and the moveable drive piston. These chambers may further be configured to receive air pressure from as source, also as described herein, or removing air, for driving the piston in one or two directions along the chamber. Optionally, one of the end walls may include an opening for allowing attachment of the drive piston and engagement feature, also as described herein. It is contemplated that this opening may be sealably engaged with the connecting feature to maintain pressure within the chamber.

The extendable member 20 includes an engagement feature, such as foot 32, adapted for extension and retraction with respect to the lift body member 12 and cylinder body. The engagement feature, and hence the drive piston, is configured for suitable movement for allowing the system to engage a pipe portion, as described herein. The engagement feature is configured for movement of about 6 inches or more, about 12 inches or more, about 18 inches or more, about 24 inches or more, or otherwise.

The engagement feature is configured for engagement with a ground surface. Preferably, upon engagement, the engagement feature is configured to reduce or substantially prevent lateral movement along the ground surface. This allows secure placement of the engagement feature and hence the system onto the ground surface. For example, in one configuration, the extendable foot includes one or more projections 34 (such as a steel spike) adapted to penetrate, at least partially, through a ground surface upon application of a suitable force, or alternatively as a result of the weight of the apparatus of the present invention. Also, the engagement feature may include outwardly projecting skirt 33 for limiting penetration of the projections into the ground surface. Optionally, the projecting skirt may be configured with one or more additional feature for reducing lateral movement.

The system further includes a drive mechanism for creating a force, in one or more directions, for moving the engagement feature. Movement of the engagement feature may be achieved using any suitable electric, mechanic, pneumatic, hydraulic force or otherwise. With the application of force, the lift body member may provide all or a portion of the force to the engagement feature, which may be reactionary to the application of force. In other word, the engagement feature may provide a counter force to the application force thereby causing an application of force, and hence movement, to the engagement feature.

In one preferred configuration, movement of the engagement feature and the drive piston is achieved with a pneumatic drive mechanism, such as an air compressor. The air compressor provides air to the lift body member and more particularly to the chamber of cylinder 19. In this configuration, the engagement feature includes a drive piston 36 moveable within the cylinder and attached to the one or more projections, skirt, or otherwise, through a rod member 42, or the like. The drive piston is in fluid communications with the drive mechanism, via one or more suitable conduits 38. Accordingly, it is contemplated that the application of pneumatic force may be to one or both sides of the piston to cause the piston to move in one or two directions. Accordingly, the cylinder may include one or more connectors 40 on either side of the drive piston for fluidly communicating with the chambers of the cylinder. However, it is contemplated that pressure may be applied to only one side of the drive piston with mechanical means (such as a spring) returning the drive piston to an original position.

Control of air pressure to the drive piston may be achieved with a suitable control module. Preferably, the control module connects the pneumatic drive mechanism to the cylinder. Accordingly, the control module may be configured to control the air flow (such as the application of air, pressure force of air, direction of air movement or otherwise) to the drive means. It is contemplated that the pneumatic drive mechanism may provide air pressure in the range of about 50 to about 150 psi.

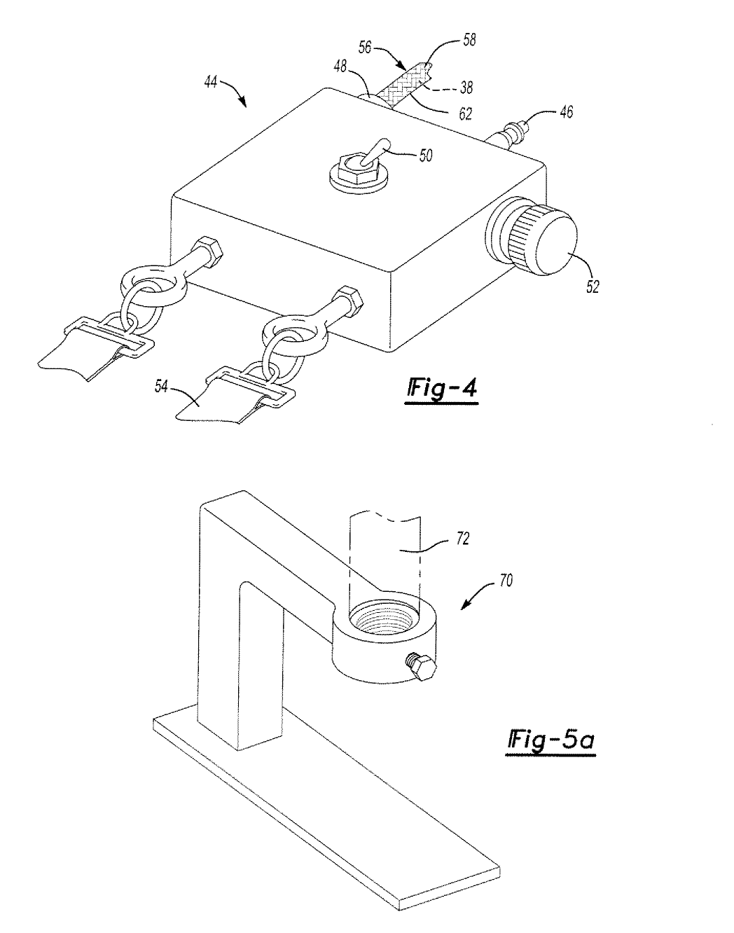

Referring to FIG. 4, an example of a suitable control module 44 is illustrated. The control module includes a first connector 46 for connection to the drive mechanism and a second fluid connector 48 for connection to cylinder 19. The module further includes a control valve 50 for controlling the flow of air to the cylinder and a pressure regulator 52 for controlling the pressure force to the drive piston. Optionally, the control module may include a suitable carrying means (such as an adjustable strap 54 or otherwise) for allowing a user to conveniently carry the control module during use of the apparatus This is particularly useful as the control module typically remains outside of the keyhole during placement of the lift body and other components into the keyhole.

In the embodiment shown, the control module is connected to the lift body member through a multi-functional flexible connector 56. The multi-functional flexible connector includes a braided rope member 58 connected to the lift body member through an eyelet 60 or the like, one or more suitable conduits 38 as previously discussed for connecting the control module to cylinder, and a reinforcing wire mesh 62 connected to the lift body member and control module for providing protection to the enclosed features. In this configuration, the system may be lowered and raised within a keyhole without applying undue force to the suitable conduits and connectors therefor. The length of the flexible connector may vary according to application. However, preferably the length of the flexible connector corresponds to at least the depth of a hole. Accordingly, it is contemplated that the flexible connector is greater than about 6, 8, 10, 12, 15, or 20 feet.

As previously mentioned, the device also includes a wrap holder assembly 28 attached to the lift body member 12. The wrap holder assembly includes a support member 64 extending from the lift body member. The support member is configured for supporting a wrap place thereon and surrounding at least a portion of a pipe 66. For example, the support member may surround approximately ⅛, ¼, ⅓, or ½ of the circumference of the pipe portion when it is placed adjacently thereto. Other configurations are available.

The wrap holder assembly also includes a retention member, such as a clip 68, for providing a suitable force for holding and maintaining placement of a wrap on the support member, or lift body, during placement of the tool within a keyhole. However, preferably the suitable force is such that it may be overcome during application of the wrap onto a pipe, as discussed herein.

Preferably, one or more components of the wrap holder assembly is removably mounted, via mechanical fasteners or otherwise, to the lift body member to allow interchangeability thereof. Accordingly, different wrap holder assembly (and more preferably support members) may be used depending on the specific application, specifically pipe dimension, or otherwise. For example, it is contemplated that the different support members may be selectively used to match the radius of an arcuate portion of the support member to the diameter or radius of the pipe portion in which the wrap is being applied to. Such arcuate portions may include radiuses (or diameters) of 2 inches, 4 inches, 6 inches, or more or less. Optionally, the radius of the arcuate portion may be increased, with respect to the radius of a given pipe portion, for providing sufficient space for locating a wrap between the arcuate portion and pipe. Such additional radius may comprise about 3/16 of an inch, through more or less may be used depending upon the desired thickness of the wrap. Accordingly, with an application of force, the support member may assist in evenly applying the wrap about a pipe portion.

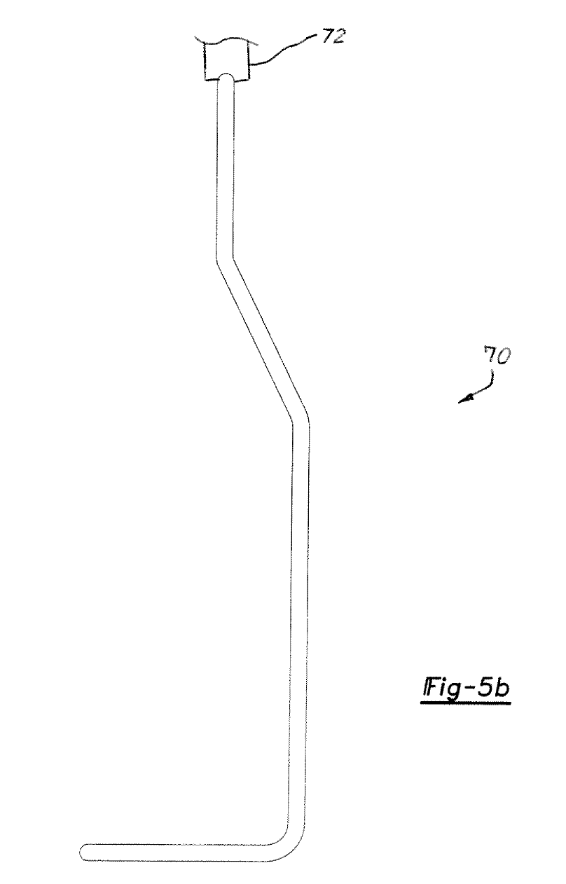

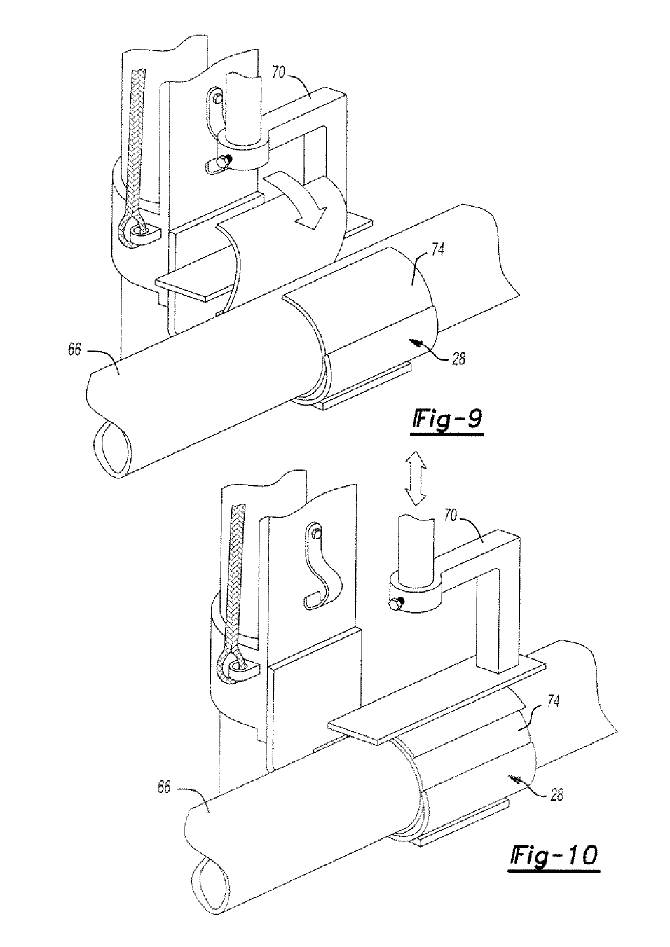

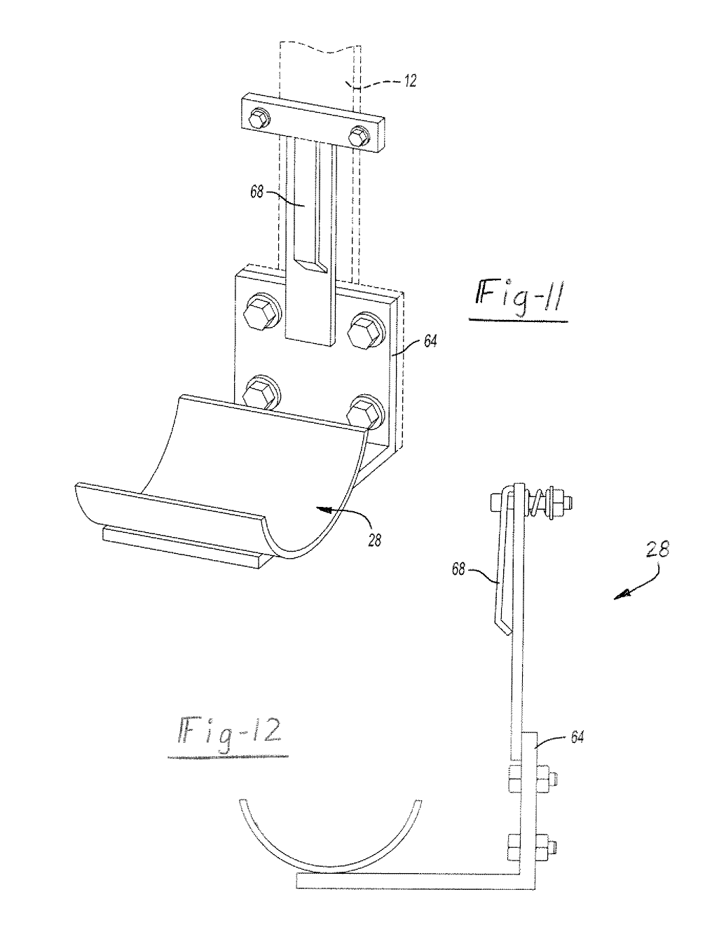

Referring to FIGS. 5a and 5b, the present invention also contemplates the use of a finishing tool 70 for assisting in the application of a wrap to the pipe portion. The finishing tool includes a handle portion 72 that may be integrally formed or threadably mounted thereto for movement within a keyhole. It should be appreciated that the handle of the finishing tool maybe interchangeable with the handle of the device. The finishing tool is configured for assisting in the application of the wrap to a pipe portion, such as smoothing the wrap over the pipe portion. Also, as shown in FIG. 9, the finishing tool assists in disengaging the wrap from the retention clip.

The wrap is configured for placement about a pipe portion. Preferably, the wrap is cut or otherwise shaped to substantially surround or otherwise wrap about a pipe portion. Accordingly, it is contemplated, as with the wrap holder, that the wrap may comprise different sizes according to the dimensions of the pipe.

Wrap material that may be used with the present invention include flexible materials. Preferably, the flexible material is also porous or otherwise configured to receive an agent applied thereto. Accordingly, it is contemplated that the wrap may include a hydrophobic agent, anti-corrosion agent, or the like, for protecting the pipe portion from corrosion.

While the agent used with the wrap may be hydrophobic, one preferred agent comprises or otherwise includes petroleum or a petroleum byproduct. Suitable generic petroleum products include oils, grease or other lubrication type products. Alternatively, or in conjunction therewith, the agent may also include wax. Suitable agent that may be used with the present invention include a petroleum, wax-based product sold by Trenton Corporation of Ann Arbor, Mich. under the trade names Graycoat, Temcoat, Temcoat 3000 and Wax-Tape Primer.

Other suitable wrap materials and agents applied thereto that may be used with the present invention can be found in commonly owned U.S. patent application Ser. No. 10/925,026, filed on Aug. 24, 2004, as described in a discussion relating to the available patch materials and agents applied thereto.

The present invention also contemplates a method of protecting underground pipe portions utilizing the teachings disclosed herein. While the method may be used with most any pipe portion, one particularly advantageous application is with pipe portions accessed through the formation of a keyhole, as described herein.

With underground pipe portion, the method includes forming a hole in a ground surface to expose the radial circumference of a pipe portion 66. While the exposure of the pipe may be achieved using traditional means, e.g., excavation of large amounts of soil using diggers, excavators, trenching machinery or otherwise, a preferred means includes accessing the pipe portion by forming a keyhole in the ground surface. Keyhole forming includes forming substantially vertical walls that extend below or proximate to a pipe portion and to a bottom surface defining the hole. The keyhole may be round, square rectangular or otherwise. However, preferably the hole has a diameter less than approximately one meter and more preferably a diameter of approximately one half meter or less. The hole may be formed using keyhole forming tools such as drills, hydro cutting/digging tools, siphoning mechanism, combinations thereof, the like or otherwise.

The keyhole formed includes a depth that is suitable for exposing the entire circumference of a pipe portion. The hole therefore may be formed at a depth corresponding to regulatory standards for placement of an underground pipe portion. It is contemplated that the keyhole formed or depth to a pipe portion located in the keyhole may include a depth of about 4 to 12 feet, or about 6 to 10 feet, greater than about 12 feet, or otherwise.

Preferably, before placement of the tool within the keyhole, the user connects the tool, via first connecter 46, to a drive mechanism such as an air compressor. The user adjusts the pressure regulator so that a suitable pressure will be applied to the drive piston 36, via conduit 38, for providing a suitable force for lifting the lift body. Optionally, the extendable foot 32 may be retracted to help position the wrap and support member under the pipe portion. Also, a handle may be attached to the lift body member 12 to assist in lowering the tool within the keyhole.

A wrap material is then provided for attachment to the tool. The wrap may be preconfigured in size and shape or it may be shaped (e.g., cut or otherwise) at the location of installation. Preferably, the shape of the wrap corresponds to the size of the pipe portion. For example, the length of the wrap may generally correspond to the circumference of the pipe. However, it should be appreciated that the wrap may be longer or shorter.

Preferably, a suitable anti-corrosion agent, as discussed herein, is applied to at least one side of the wrap, onto the pipe portion, or both. More preferably, it is applied to the side opposite of the support member when placed thereon during installation. The agent may be applied at the location of installation, or alternatively the agent may be pre-applied elsewhere or both.

Optionally, a specific wrap holder assembly 28 may be selected and attached to the lift body member 12, if not already attached. Preferably, the wrap holder assembly includes a support member 64 having a corresponding shape to that of a pipe portion 66 (e.g., arcuate or otherwise). More preferably, the arcuate portion of the support member includes a diameter or radius approximately the same or slightly larger (e.g. 3/16 or an inch or otherwise) than the diameter or radius of the outer circumference of the pipe.

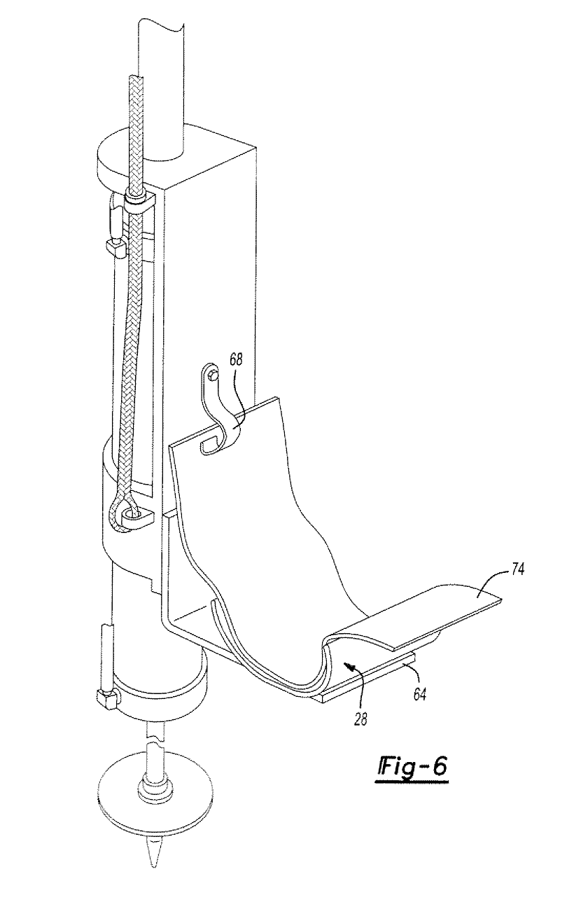

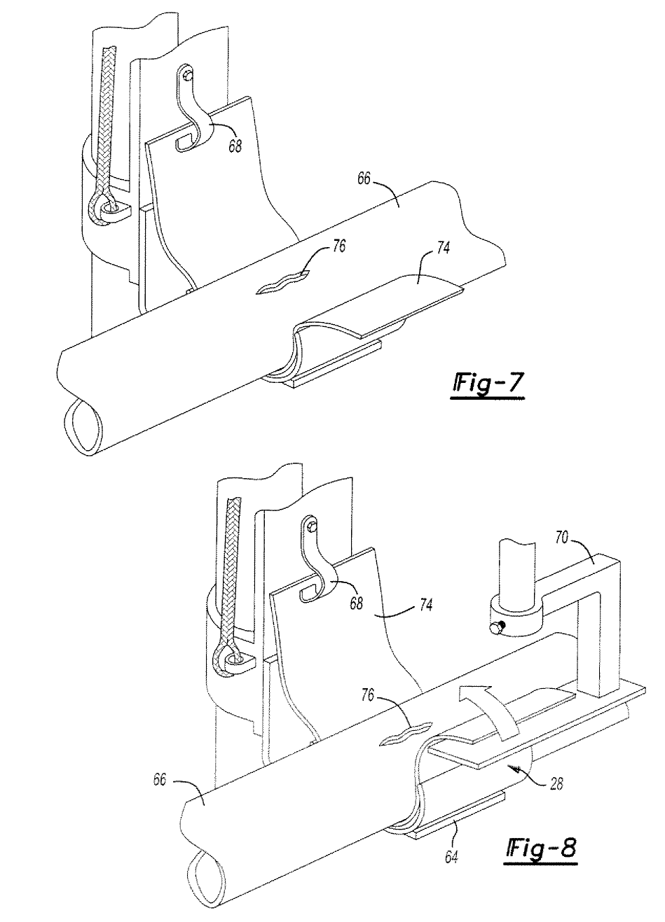

Referring to FIGS. 6 though 10, upon exposure of the pipe, a wrap 74 is attached to the device 10 via retention clip 68 and is supported by support member 64. The member is lowered within the keyhole and the support member and wrap are positioned under the exposed pipe portion 66 such that the center of the support member is generally located below a center portion of the pipe. Advantageously, handle 24 may be used to lower and position the device as described above. However, it is contemplated that the multi-functional flexible connector 56, due to its reinforced nature, may also be used to lower and position the tool. Upon placement of the tool, the one or more projection 34 extending from the engagement feature may be inserted into the soil to prevent lateral movement of the tool.

Upon placement of the tool beneath the pipe portion and suitable engagement with the ground surface, the user switches the control valve 50 to allow a pressure from the drive mechanism to be applied to the drive piston 36 of the extension member 20. The pressure results in movement of the drive piston within a cylinder thereby causing the extendable foot 32 to move with respect to the first end of the lift body member 12. In response to the resistance force of the bottom surface of the keyhole, the lift body raises with respect to the bottom surface. As the wrap holder 28 is mounted to the lift body member, the wrap 74 and the support member 64 are raised towards the pipe portion. The support member continues to move towards the pipe portion until the resistance of the pipe portion is equal to that of the pressure being applied to the drive piston or until the pressure is turned off by the user, or both. Preferably, upon cessation of movement, the support member and wrap substantially surround approximately one half or less of the pipe portion.

The user then switches the control valve off, or otherwise release the pressure to the drive piston, or move the piston in an opposite direction, or maintains pressure to keep the support member proximate to the pipe portion. The user then lowers the finishing tool 70 within the keyhole proximate to the support member 64 and wrap 74. As shown in FIGS. 8 through 10, the user then uses the finishing tool to remove the wrap from the retention clip 68 and smoothes the wrap about the pipe portion 66. Preferably, the wrap substantially covers the outer radial circumference of the pipe portion and more preferably any holiday 76 formed in the coating of the pipe. Upon completion, the finishing tool is removed and the engagement feature is retracted and the pipe wrap tool is removed. Alternatively, the finishing tool may be used to hold the wrap in place during retraction of the engagement feature or removal of the system from the hole. The resulting product comprises a pipe portion having a wrap substantially about the radial circumference of the pipe, preferably with an intermediary layer of anti-corrosion agent for protecting the covered pipe portion from corrosion. Optionally, the keyhole may then be filled.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A system for applying a protective wrap to a pipe portion, the system including:
a lift body being attached or including a handle for lowing into a hole;
an extendable member moveably attached to the lift body, the extendable member including an engagement feature adapted to extend and retract with respect to the lift body;
a support member attached or movable with the lift body
a retention member attached to the support member or lift body for temporarily securing a protective wrap over the support member;
a drive mechanism for providing an application of force to the extendable member to extend, retract, or extend and retract the engagement feature; and
a control module for controlling the application of force by the drive mechanism to the engagement feature.

2. The system of claim 1, wherein the lift body includes an attachment feature for releasable attachment of the handle.

3. The system of claim 1, wherein the extendable member includes a drive piston connected to the engagement feature, the drive piston being moveable through an application of force by the drive mechanism to move the engagement feature between the extended and retracted position.

4. The system of claim 3, wherein the control module controls the amount of force being applied to the drive piston, the direction of force being applied to the drive piston, or both.

5. The system of claim 4, wherein the application of force comprises electricity, hydraulics, pneumatics, or combinations thereof.

6. The system of claim 4, wherein the application of force comprises pneumatic force selectively applied to opposites sides of the drive piston to cause the extension and retraction of the engagement feature.

7. The system of claim 4, wherein the drive mechanism comprises an air compressor in fluid communications with the control module which is selectively in further fluid communications with drive piston of the extendable member.

8. The system of claim 1, wherein the engagement feature includes one or more features for limiting lateral movement of the engagement feature with respect to a ground surface of the hole.

9. The system of claim 1, wherein the handle is suitable in length for lowering the system approximately 4 to 12 feet into the hole.

10. The system of claim 1, wherein the handle is suitable in length for lowering the system approximately 6 to 10 feet into the hole.

11. The system of claim 1, wherein the retention member comprises a clip for maintaining the protective wrap over the support member and wherein the wrap includes a petroleum waxed based product.

12. The system of claim 1, further comprising disengaging tool for disengaging the protective wrap from the retention member and for smoothing the wrap over a pipe portion.

13. The system of claim 11, wherein the support member includes an arcuate portion having a diameter generally corresponding to a pipe portion located in the hole.

14. A system for applying a protective wrap to a pipe portion, the system including:
a lift body including a handle, the lift body being configured for lowering into a hole between about 4 to 10 feet;
an extendable member attached to the lift body, the extendable member including drive piston movably placed within extendable member, the drive piston being connected to an engagement feature adapted to extend and retract with respect to the lift body;
a support member attached or movable with the lift body, the support member including an arcute portion having a diameter;
a retention member attached to the support member or lift body for temporarily securing a protective wrap over the support member;
an air compressor in fluid communications with a first and second side of the drive piston for providing an application of pneumatic force to the extendable member to extend, retract, or extend and retract the engagement feature; and
a control module for controlling the application of force by the drive mechanism to the drive piston.

15. A method of applying a protective wrap to a pipe portion within a keyhole, the method including the steps of:
forming a hole to expose an underground pipe portion, the underground pipe portion having a holiday formed in a protective coating of the pipe portion;
lowering a wrapping system within the hole, the wrapping system including:
a lift body being attached or including a handle for lowing into a hole,
an extendable member moveably attached to the lift body and including an engagement feature adapted to extend and retract with respect to the lift body,
a support member attached to the lift body, and
a retention member attached to the support member or lift body for temporarily securing a protective wrap over the support member;
placing the support member below the pipe portion;
extending the engagement feature to raise the support member until the protective wrap come in at least partially contact with the pipe portion;
wrapping any remaining portion of the wrap around the pipe portion;
retracting the engagement feature causing the support member to move away from the pipe portion; and
removing the wrapping system from the hole.

16. The method of claim 15, wherein the hole comprise a keyhole having a diameter of about meter or less.

17. The method of claim 15, wherein the hole comprises a keyhole having a diameter equal to or less than about one half meter.

18. The method of claim 15, further including the step of applying an anticorrosion agent over the protective wrap prior to placement of the wrap onto the support member.

19. The method of claim 15, wherein the resulting formed hole is between 4 to 12 feet deep.

20. The method of claim 15, wherein the resulting formed hole is between 6 to 10 feet deep.
